(19) United States
(12) Patent Application Publication
(10) Pub. No.: US 2014/0363667 A1
(43) Pub. Date: Dec. 11, 2014

(54) SEPARATOR-ATTACHED PRESSURE-SENSITIVE ADHESIVE LAYER, METHOD FOR PRODUCING THE SAME AND PRESSURE-SENSITIVE ADHESIVE LAYER-ATTACHED OPTICAL FILM WITH SEPARATOR

(71) Applicant: NITTO DENKO CORPORATION, Osaka (JP)

(72) Inventors: Atsushi Yasui, Ibaraki-shi (JP); Yuusuke Toyama, Ibaraki-shi (JP); Takaaki Ishii, Ibaraki-shi (JP); Masakuni Fujita, Ibaraki-shi (JP)

(73) Assignee: NITTO DENKO CORPORATION, Osaka (JP)

(21) Appl. No.: 14/299,214

(22) Filed: Jun. 9, 2014

(30) Foreign Application Priority Data
Jun. 10, 2013 (JP) 2013-122034

(51) Int. Cl. C09J 7/02; C09J 5/06; B32B 7/12

(52) U.S. Cl. CPC C09J 7/0225; B32B 7/12; C09J 5/06
USPC 428/352; 428/500; 427/208.4

(57) ABSTRACT

A separator-attached pressure-sensitive adhesive layer of the present invention including a pressure-sensitive adhesive layer on a separator, wherein the separator includes a base film and an oligomer prevention layer, and a release layer provided in this order on the base film, and the release layer has a surface resistance value of 1.0×10¹³Ω/□ or more, and the pressure-sensitive adhesive layer is formed from a pressure-sensitive adhesive composition including a base polymer and an ionic compound and is provided on the release layer of the separator. The separator-attached pressure-sensitive adhesive layer is capable of inhibiting an oligomer contained in the base film used for the separator from migrating into the pressure-sensitive adhesive layer.

### BACKGROUND OF THE INVENTION

1. Field of the Invention

The present invention relates to a separator-attached pressure-sensitive adhesive layer and a method for producing the same. Moreover, the present invention relates to a pressure-sensitive adhesive layer-attached optical film with a separator prepared by sticking the above-mentioned separator-attached pressure-sensitive adhesive layer to an optical film.

There can be used, as the optical film, a polarizing film, a retardation plate, an optical compensation film, a brightness enhancement film, a surface treatment film such as an anti-reflection film and laminations thereof. A pressure-sensitive adhesive layer-attached optical film resulting from peeling the separator off from the pressure-sensitive adhesive layer-attached optical film with a separator is applied to an image display device such as a liquid crystal display device, an organic EL display device, a CRT, and a PDP and a member to be used together with an image display device, such as a front panel.

2. Description of the Related Art

Optical films such as polarizing films are used for image display devices, such as liquid crystal display devices, and front panels, etc. When the optical films are stuck to a liquid crystal cell, pressure-sensitive adhesives are generally used. Sticking between an optical film and a liquid crystal cell or between optical films is generally performed with a pressure-sensitive adhesive in order to reduce optical loss. In such a case, a pressure-sensitive adhesive layer-attached polarizing film including a polarizing film and a pressure-sensitive adhesive layer previously formed on one side of the polarizing film is generally used, because it has some advantages such as no need for a drying process to fix the polarizing film. A pressure-sensitive adhesive layer-attached optical film is usually produced by attaching a pressure-sensitive adhesive layer formed on a separator to an optical film.

During the manufacture of a liquid crystal display, the pressure-sensitive adhesive layer-attached optical film (e.g. the pressure-sensitive adhesive layer-attached polarizing film) is stuck to a liquid crystal cell. In this process, static electricity is generated when the separator is peeled off from the pressure-sensitive adhesive layer of the pressure-sensitive adhesive layer-attached optical film. The static electricity generated in this manner may affect the orientation of the liquid crystal in the liquid crystal display to cause a failure. The static electricity may also cause display unevenness when the liquid crystal display operates. For example, the static generation can be suppressed when an antistatic layer is formed on the outer surface of the optical film, but its effect is not high, and there is a problem in which static generation cannot be fundamentally prevented. To suppress static generation in a fundamental position, therefore, the pressure-sensitive adhesive layer is required to have an antistatic function. Concerning means for providing an antistatic function to a pressure-sensitive adhesive layer, for example, it has been proposed that an ionic compound should be added to a pressure-sensitive adhesive used to forma pressure-sensitive adhesive layer (Patent Documents 1 and 2). There has been also proposed a pressure-sensitive adhesive layer-attached polarizing film prepared by forming an antistatic layer from a conducting polymer between a polarizing film and a pressure-sensitive adhesive layer (Patent Document 3).

On the other hand, a separator to be used for a pressure-sensitive adhesive layer-attached optical film has a problem that an oligomer contained in abase film (e.g., a polyester film) used for the separator migrates to the pressure-sensitive adhesive layer. It has been proposed to provide an oligomer prevention layer (a migration preventive layer) in order to prevent this problem (Patent Document 4). In Patent Document 4, a resin layer such as an acryl-based resin layer, a urethane-based resin layer and a silicone-based resin layer, tin oxide, indium oxide, or a composite thereof is used for the formation of the oligomer prevention layer. It has been proposed to suppress the precipitation of an oligomer from a polyester film by providing a coating layer containing a quaternary ammonium salt-containing polymer and subsequently an oligomer prevention layer containing a metal element-containing organic compound onto the polyester film (Patent Document 5).

### PRIOR ART DOCUMENTS

### Patent Documents

Patent Document 1: JP-A No. 06-128539

Patent Document 2: JP-A No. 2007-536427

Patent Document 3: JP-A No. 2003-246874

Patent Document 4: JP-A No. 2000-227503

Patent Document 5: JP-A No. 2011-093173

### SUMMARY OF THE INVENTION

### Problems to be Solved by the Invention

In the case of having formed a pressure-sensitive adhesive layer containing an ionic compound on a separator in order to impart an antistatic function and further having formed an oligomer prevention layer from the material containing a quaternary ammonium salt-containing polymer disclosed in Patent Document 5, it has been found that the migration of an oligomer contained in the base film used for the separator into the pressure-sensitive adhesive layer cannot be inhibited sufficiently. This is believed to be because the function of the oligomer prevention layer is deteriorated by the ionic compound in the pressure-sensitive adhesive layer due to good compatibility between the ionic compound in the pressure-sensitive adhesive layer and the quaternary ammonium salt polymer.

It is an object of the present invention to provide a separator-attached pressure-sensitive adhesive layer capable of, even when a pressure-sensitive adhesive layer containing an ionic compound is formed on a separator, inhibiting an oligomer contained in a base film used for the separator from migrating into the pressure-sensitive adhesive layer, and a method for producing the same.

Moreover, it is another object of the present invention to provide a pressure-sensitive adhesive layer-attached optical film with a separator in which the above-mentioned separator-attached pressure-sensitive adhesive layer is stuck to at least one side of the optical film.

### Means for Solving the Problems

As a result of investigations for solving the problems, the inventors have found the separator-attached pressure-sensitive adhesive layer described below and have completed the present invention.

The present invention relates to a separator-attached pressure-sensitive adhesive layer including a pressure-sensitive adhesive layer on a separator, wherein

the separator includes a base film and an oligomer prevention layer, and a release layer provided in this order on the base film, and the release layer has a surface resistance value of 1.0×10¹³Ω/□ or more, and

the pressure-sensitive adhesive layer is formed from a pressure-sensitive adhesive composition including a base polymer and an ionic compound and is provided on the release layer of the separator.

In the separator-attached pressure-sensitive adhesive layer, the oligomer prevention layer is preferably a layer formed of a silica-based material.

In the separator-attached pressure-sensitive adhesive layer, the ionic compound is preferably an alkali metal salt and/or an organic cation-anion salt.

In the separator-attached pressure-sensitive adhesive layer, a (meth)acryl-based polymer is able to be used as the base polymer.

The (meth)acryl-based polymer preferably includes an alkyl (meth)acrylate monomer unit and a hydroxyl group-containing monomer unit. The (meth)acryl-based polymer preferably also includes an alkyl (meth)acrylate monomer unit and a carboxyl group-containing monomer unit.

The present invention also relates to a method for producing the above separator-attached pressure-sensitive adhesive layer, including the steps of:

applying a solution of a pressure-sensitive adhesive composition including a base polymer and an ionic compound to a release layer of a separator, the separator including a base film and an oligomer prevention layer, and the release layer provided in this order on the base film, and the release layer having a surface resistance value of 1.0×10¹³Ω/□ or more, and heating the applied solution of the pressure-sensitive adhesive composition at a temperature of 140° C. or more.

The present invention relates to a pressure-sensitive adhesive layer-attached optical film with a separator, wherein the above separator-attached pressure-sensitive adhesive layer is stuck to at least one side of the optical film.

### Effect of the Invention

The pressure-sensitive adhesive layer according to the separator-attached pressure-sensitive adhesive layer of the present invention contains an ionic compound and therefore has an antistatic function. It is considered that reduction in the surface resistance value of the pressure-sensitive adhesive layer as a result of bleeding out of the ionic compound to the surface of the pressure-sensitive adhesive layer allows an antistatic function to be developed efficiently.

The separator of the separator-attached pressure-sensitive adhesive layer of the present invention has the configuration in which an oligomer prevention layer and a release layer are provided in this order on a base film and the release layer is controlled so as to have a surface resistance value of 1.0×10¹³Ω/□ or more. Thus, in the present invention, the surface resistance value of the release layer being in contact with the pressure-sensitive adhesive layer is set at a large value equal to or greater than a prescribed value while the surface resistance value of the pressure-sensitive adhesive layer is adjusted to a reduced value. The release layer having a surface resistance value controlled to such a large value is considered to be capable of inhibiting the function of the oligomer prevention layer from deteriorating due to the bleeding out of the ionic compound from the pressure-sensitive adhesive layer. As a result, even when a pressure-sensitive adhesive layer containing an ionic compound is formed on a separator (a release layer), it is possible to inhibit an oligomer contained in a base film used for the separator from migrating into the pressure-sensitive adhesive layer.

### DETAILED DESCRIPTION OF THE PREFERRED EMBODIMENTS

The separator-attached pressure-sensitive adhesive layer of the present invention has a configuration that contains a pressure-sensitive adhesive layer on a separator. In the separator, an oligomer prevention layer and a release layer are provided in this order on a base film.

The surface of the release layer is controlled so as to have a surface resistance value of 1.0×10¹³Ω/□ or more. The surface resistance value of the release layer can be controlled, for example, by selecting the material to form the oligomer prevention layer. If the surface resistance value is less than 1×10¹³Ω/□, then an antistatic function is imparted to the release layer, so that deterioration of the function of the oligomer prevention layer caused by the bleeding out of an ionic compound from the pressure-sensitive adhesive layer cannot be suppressed sufficiently.

A plastic film is used as the base film of the separator. Examples of such a plastic film include polyolefin films such as a polyethylene film, a polypropylene film, a polybutene film, a polybutadiene film and a polymethylpentene film; vinyl chloride-based films such as a polyvinyl chloride film and a vinyl chloride copolymer film; polyester films such as a polyethylene terephthalate film, a polybutylene terephthalate film and a polynaphthylene terephthalate film; as well as a polyurethane film and an ethylene-vinyl acetate copolymer film. Although the present invention intends to prevent the migration of an oligomer contained in the base film, the present invention can be applied suitably when a polyester film is used among the above-mentioned options of the base film.

The thickness of the base film is usually 5 to 200 μm, preferably 5 to 100 μm. In forming the oligomer prevention layer, the base film may be subjected beforehand to surface treatment such as corona treatment and plasma treatment.

The oligomer prevention layer may be formed from a material suitable, for example, for preventing migration of migrating components contained in a base film (e.g., a polyester film), especially low molecular weight oligomer components of a polyester. An inorganic compound, an organic compound, or a composite material thereof can be used as the material that forms the oligomer prevention layer.

Preferably, the thickness of the oligomer prevention layer is set appropriately within the range of 5 to 100 nm. Moreover, the thickness of the oligomer prevention layer is preferably 10 to 70 nm. The formation method of the oligomer prevention layer is not particularly restricted and may be selected suitably depending upon the material for forming the layer and, for example, an application method, a spraying method, a spin-coating method, an in-line coating method, and so on are used. Moreover, a vacuum deposition method, a sputtering method, an ion plating method, a spray thermal decomposition method, a chemical plating method, an electroplating method, and so on can also be used.

The surface resistance value of the release layer can be controlled so as to be 1.0×10Ω/□ or more by selecting the material of the oligomer prevention layer. A silica-based material can be used preferably as the material of the oligomer prevention layer.

Examples of the silica-based material include a silane compound (organosiloxane) represented by the following formula (I):

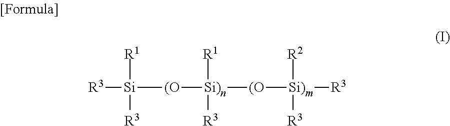

In the above formula (I), R¹ and R² are each independently an organic group having an epoxy group such as a γ-glycidoxypropyl group and a 3,4-epoxycyclohexylethyl group or an alkoxy group such as a methoxy group and an ethoxy group, and R³ is an alkoxy group such as a methoxy group and an ethoxy group or a group represented by the following formula (II). n and m are each an integer of 0 to 10.

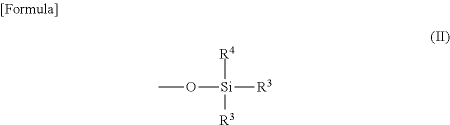

In the above formula (II), R⁴ is an epoxy group-containing organic group or an alkoxy group, which are the same as those for the R′ group or the R² group.

Specific examples of the organosiloxane include monomers such as γ-glycidoxypropyltrimethoxysilane, 2-(3,4-epoxycyclohexyl)ethyltrimethoxysilane, 2-(3,4-epoxycyclohexyl)ethyltriethoxysilane, 5,6-epoxyhexyltriethoxysilane, tetraethoxysilane, and tetraethoxysilane, and hydrolysates of such monomers or hydrolysates of mixtures of such monomers (oligomers).

Examples of the silica-based material include a silane compound having an amino group. An alkoxysilane represented by the following formula (III) is preferred as the silane compound having an amino group:

Y—R—Si—(X)₃ (III)

wherein Y represents an amino group, R represents an alkylene group such as methylene, ethylene and propylene, and X represents an alkoxy group such as a methoxy group and an ethoxy group, an alkyl group, or an organic functional group having such a group.

Specific examples of the silane compound having an amino group include N-β(aminoethyl)-γ-aminopropyltrimethoxysilane, N-β(aminoethyl)-γ-aminopropyltriethoxysilane, N-β(aminoethyl)-γ-aminopropylmethyldimethoxysilane, γ-aminopropyltrimethoxysilane, and N-phenyl-γ-aminopropyltrimethoxysilane.

Examples of the silica-based material include (meth)acryl group-containing silane compounds such as 3-acryloxypropyltrimethoxysilane and 3-methacryloxypropyltriethoxysilane, and isocyanate group-containing silane compounds such as 3-isocyanatopropyltriethoxysilane.

Examples of specific products of the silica-based material include KR-401N, X-40-9227, X-40-9247, KR-510, KR-9218, KR-213, KR-217, X-41-1053, X-40-1056, X-41-1805, X-41-1810, X-40-2651, X-40-2652B, X-40-2655A, X-40-2761, and X-40-2672 manufactured by Shin-Etsu Chemical Co., Ltd.

The material that forms the oligomer prevention layer may, as necessary, contain an organic compound containing a metal element (a metal compound such as a metal chelate), a catalyst, etc. As to such metal organic compounds, only one compound may be used or alternatively two or more compounds may be used as a mixture.

Specific examples of an organic compound containing an aluminum element include aluminum tris(acetylacetonate), aluminum monoacetylacetonate bis(ethylacetoacetate), aluminum di-n-butoxide-monoethylacetoacetate, and aluminum di-iso-propoxide-monomethylacetoacetate.

Specific examples of an organic compound having a titanium element include titanium orthoesters such as tetra-n-butyl titanate, tetraisopropyl titanate, butyl titanate dimer, tetra(2-ethylhexyl) titanate and tetramethyl titanate; and titanium chelates such as titanium acetylacetonate, titanium tetraacetylacetonate, polytitaniumacetylacetonate, titanium octylene glycolate, titanium lactate, titanium triethanolaminate, and titanium ethylacetoacetate.

Specific examples of an organic compound having a zirconium element include zirconium acetate, zirconium n-propylate, zirconium n-butyrate, zirconium tetraacetylacetonate, zirconium monoacetylacetonate, and zirconium bisacetylacetonate.

Among these, especially, organic compounds having a chelate structure such as organic compounds having an aluminum element, organic compounds having a titanium element and organic compounds having a zirconium element are preferred in that performance of preventing oligomers from precipitating is good. Such compounds are disclosed concretely in “Crosslinking Agent Handbook” (edited by Shinzo Yamashita and Tosuke Kaneko, TAISEISHA LTD. (1990)).

A water-soluble or water-dispersible binder resin other than the silica-based material may be used together for the material that forms the oligomer prevention layer. Examples of such a binder resin include polyvinyl alcohol, polyester, polyurethane, an acrylic resin, a vinyl resin, an epoxy resin, and an amide resin. The backbone structure of each of these may substantially have a composite structure due to copolymerization or the like. Examples of the binder resin having a composite structure include acrylic resin-grafted polyester, acrylic resin-grafted polyurethane, vinyl resin-grafted polyester, and vinyl resin-grafted polyurethane. The amount of the binder component to be blended is preferably within the range of 50 parts by weight or less, more preferably within the range of 30 parts by weight or less when the overall amount of the oligomer prevention layer is taken as 100 parts by weight. As to the binder resin, polymers having a quaternary ammonium salt group are preferably excluded from the binder resin to be used for the present invention because the function of the oligomer prevention layer is thought to be deteriorated by the ionic compound in the pressure-sensitive adhesive layer.

The material that forms the oligomer prevention layer may, as necessary, contain a crosslinking reactive compound. Specific examples of the crosslinking reactive compound include methylolated or alkylolated urea-based compounds, melamine-based compounds, guanamine-based compounds, acrylamide-based compounds, or polyamide-based compounds, epoxy compounds, aziridine compounds, block polyisocyanate, silane coupling agents, titanium coupling agents, and zirconate-aluminate coupling agents. These crosslinking components may have been previously bonded to a binder resin.

The oligomer prevention layer can be formed by applying to a base film and then drying a solution prepared by appropriately dissolving the silica-based material in a solvent. The drying temperature to be used after the application, which is not particularly limited, is preferably about 100 to about 150° C.

A release layer is subsequently provided on the oligomer prevention layer. The release layer is provided in order to improve a peeling property from the pressure-sensitive adhesive layer. The material that forms the release layer is not particularly restricted and examples thereof include silicone-based release agents, fluorine-containing release agents, long-chain alkyl-based release agents, and fatty acid amide-based release agents. Among these, silicone-based release agents are preferred. The release layer may be formed as a coating layer on the oligomer prevention layer. The thickness of the release layer is usually 10 to 2000 nm, preferably 10 to 1000 nm, more preferably 10 to 500 nm.

Examples of the silicone-based release agent include addition reactive silicone resins. Examples thereof include KS-774, KS-775, KS-778, KS-779H, KS-847H, and KS-847T manufactured by Shin-Etsu Chemical Co., Ltd., TPR-6700, TPR-6710, and TPR-6721 manufactured by Toshiba Silicones, and SD7220 and SD7226 manufactured by Dow Corning Toray Co., Ltd. The applied amount of the silicone-based release agent (after drying) is preferably within the range of 0.01 to 2 g/m², more preferably 0.01 to 1 g/m², even more preferably 0.01 to 0.5 g/m².

The formation of a release layer can be carried out, for example, by applying the above-mentioned material onto an oligomer prevention layer by a conventional coating method such as reverse gravure coating, bar coating, and die coating, and then applying heat treatment usually at about 120 to 200° C. to cure the material. The heat treatment may, as necessary, be used together with active energy ray irradiation such as DV irradiation.

The separator-attached pressure-sensitive adhesive layer of the present invention has a pressure-sensitive adhesive layer formed from a pressure-sensitive adhesive composition containing a base polymer and an ionic compound on the release layer of the separator.

The pressure-sensitive adhesive layer is formed from a pressure-sensitive adhesive. Various types of pressure-sensitive adhesives can be used as the pressure-sensitive adhesive. Examples thereof include rubber-based pressure sensitive adhesives, acryl-based pressure sensitive adhesives, silicone-based pressure sensitive adhesives, urethane-based pressure-sensitive adhesives, vinyl alkyl ether-based pressure-sensitive adhesives, polyvinyl alcohol-based pressure-sensitive adhesives, polyvinylpyrrolidone-based pressure-sensitive adhesives, polyacrylamide-based pressure-sensitive adhesives, and cellulose-based pressure-sensitive adhesives. A pressure-sensitive adhesive base polymer is selected according to the type of the pressure-sensitive adhesive.

Among the above-mentioned pressure-sensitive adhesives, acryl-based pressure-sensitive adhesives are preferably used because of their excellent optical transparency, their appropriate exhibition of adhering characteristics including wettability, cohesiveness and tackiness, and their excellence in weather resistance, heat resistance, etc. The acryl-based pressure-sensitive adhesives contain a (meth)acryl-based polymer as a base polymer. The (meth)acryl-based polymer includes an alkyl (meth)acrylate monomer unit as a main component. The term “(meth)acrylate” refers to acrylate and/or methacrylate, and “(meth)” is used in the same meaning in the description.

The alkyl (meth)acrylate used to form the main skeleton of the (meth)acryl-based polymer may have a straight- or branched-chain alkyl group of 1 to 18 carbon atoms. Examples of such an alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl and octadecyl groups. These may be used singly or in any combination. The average number of carbon atoms in the alkyl group is preferably from 3 to 9.

An aromatic ring-containing alkyl (meth)acrylate such as phenoxyethyl (meth)acrylate or benzyl (meth)acrylate may also be used in view of control of adhesive properties, durability, retardation, refractive index, or the like. A polymer obtained by polymerizing the aromatic ring-containing alkyl (meth)acrylate may be used in a mixture with any of the above examples of the (meth)acryl-based polymer. In view of transparency, however, a copolymer obtained by polymerizing the aromatic ring-containing alkyl (meth)acrylate and the above alkyl (meth)acrylate is preferably used.

The content of the aromatic ring-containing alkyl (meth)acrylate component in the (meth)acryl-based polymer may be 50% by weight or less based on the content (100% by weight) of all the monomer components of the (meth)acryl-based polymer. The content of the aromatic ring-containing alkyl (meth)acrylate is preferably from 1 to 35% by weight, more preferably from 1 to 20% by weight, even more preferably from 7 to 18% by weight, still more preferably from 10 to 16% by weight.

In order to improve tackiness or heat resistance, one or more copolymerizable monomers having an unsaturated double bond-containing polymerizable functional group such as a (meth)acryloyl group or a vinyl group may be introduced into the (meth)acryl-based polymer by copolymerization. Examples of such copolymerizable monomers include hydroxyl group-containing monomers such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of such a monomer for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethyl itaconimide, N-butylitaconimide, N-octylitaconimide, N-2-ethylhexylitaconimide, N-cyclohexylitaconimide, and N-laurylitaconimide.

Examples of modification monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate. Examples also include isoprene, butadiene, isobutylene, and vinyl ether.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

Concerning the weight ratios of all monomer components, the alkyl (meth)acrylate should be a main component of the (meth)acryl-based polymer, and the content of the copolymerizable monomer used to form the (meth)acryl-based polymer is preferably, but not limited to, 0 to about 20%, more preferably about 0.1 to about 15%, even more preferably about 0.1 to about 10%, based on the total weight of all monomer components.

Among these copolymerizable monomers, a hydroxyl group-containing monomer is preferably used in view of tackiness or durability. The hydroxyl group-containing monomer is highly reactive with intermolecular crosslinking agents and therefore is preferably used to improve the cohesiveness or heat resistance of the resulting pressure-sensitive adhesive layer. The hydroxyl group-containing monomer is preferred in terms of reworkability. When the hydroxyl group-containing monomer is added as a copolymerizable monomer, the proportion thereof is preferably from 0.01 to 15% by weight, more preferably from 0.03 to 10% by weight, even more preferably from 0.05 to 7% by weight.

A carboxyl group-containing monomer is preferred in terms of balancing durability and reworkability. When the carboxyl group-containing monomer is added as a copolymerizable monomer, the proportion thereof is preferably 0.05 to 10% by weight. In particular, oligomers contained in a base film are facilitated to migrate and precipitate with decrease in the proportion of the carboxyl group-containing monomer. The present invention is particularly effective when the proportion of the carboxyl group-containing monomer is 4% by weight or less. The proportion of the carboxyl group-containing monomer is preferably 0.05 to 4% by weight, more preferably 0.1 to 3% by weight, even more preferably 0.2 to 2% by weight.

In an embodiment of the present invention, the (meth)acryl-based polymer used generally has a weight average molecular weight in the range of 500,000 to 3,000,000. In view of durability, particularly in view of heat resistance, the weight average molecular weight of the polymer used is preferably from 700,000 to 2,700,000, more preferably from 800,000 to 2,500,000. If the weight average molecular weight is less than 500,000, it is not preferred in view of heat resistance. If a weight average molecular weight is more than 3,000,000, it is not preferred because a large amount of a dilution solvent may be necessary for control of coating viscosity, which may increase cost. The weight average molecular weight refers to the value obtained by measurement by gel permeation chromatography (GPC) and conversion of the measured value into the polystyrene-equivalent value.

For the production of the (meth)acryl-based polymer, any appropriate method may be selected from known production methods such as solution polymerization, bulk polymerization, emulsion polymerization, and various radical polymerization methods. The resulting (meth)acryl-based polymer may be any type of copolymer such as a random copolymer, a block copolymer and a graft copolymer.

In a solution polymerization process, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent and monomers concentration. The amount of the addition may be controlled as appropriate depending on the type of these materials.

Examples of the polymerization initiator include, but are not limited to, azo initiators such as 2,2′-azobisisobutylonitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator is preferably from about 0.005 to 1 part by weight, more preferably from about 0.02 to about 0.5 parts by weight, based on 100 parts by weight of the monomer.

For example, when 2,2′-azobisisobutyronitrile is used as a polymerization initiator for the production of the (meth)acryl-based polymer with the above weight average molecular weight, the polymerization initiator is preferably used in a content of from about 0.06 to 0.2 parts by weight, more preferably of from about 0.08 to 0.175 parts by weight, based on 100 parts by weight of the total content of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One of these chain transfer agents may be used alone, or two or more thereof may be used in a mixture. The total content of the chain transfer agent is preferably 0.1 parts by weight or less, based on 100 parts by weight of the total content of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by Asahi Denka Kogyo K.K.). The reactive emulsifier is preferred, because after polymerization, it can be incorporated into a polymer chain to improve water resistance. Based on 100 parts by weight of the total monomer component, the emulsifier is preferably used in a content of 0.3 to 5 parts by weight, more preferably of 0.5 to 1 parts by weight, in view of polymerization stability or mechanical stability.

The pressure-sensitive adhesive composition of the present invention further contains the ionic compound in addition to the base polymer (e.g. the (meth)acryl-based polymer). The ionic compound to be used is preferably an alkali metal salt and/or an organic cation-anion salt. Any of organic and inorganic salts of alkali metals may be used as the alkali metal salt. As used herein, the term “organic cation-anion salt” refers to an organic salt including an organic cation moiety, in which the anion moiety may be organic or inorganic. The “organic cation-anion salt” is also referred to as the ionic liquid or the ionic solid.

### <Alkali Metal Salt>

The cation moiety of the alkali metal salt includes an alkali metal ion, which may be any of lithium, sodium, and potassium ions.

Among these alkali metal ions, lithium ion is particularly preferred.

The anion moiety of the alkali metal salt may include an organic material or an inorganic material. Examples of the anion moiety that may be used to form the organic salt include CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂)(CF₃CO)N⁻, O₃S(CF₂)₃SO₃⁻, PF₆⁻, and CO₃²⁻ and those represented by the following general formulae (1) to (4):

(CₙF₂ₙ₊₁SO₂)₂N⁻ (1),

wherein n is an integer of 1 to 10;

CF₂(CₘF₂ₘSO₂)₂N⁻ (2),

wherein m is an integer of 1 to 10;

⁻O₃S(CF₂)ₗSO₃ (3),

wherein l is an integer of 1 to 10; and

(CₚF₂ₚ₊₁SO₂)N(C_{q}F_{2q+1}SO₂) (4),

wherein p and q are each an integer of 1 to 10. In particular, a fluorine atom-containing anion moiety is preferably used because it can form an ionic compound with good ionic dissociation properties. Examples of the anion moiety that may be used to form the inorganic salt include Cl⁻, Br⁻, I⁻, AlCl₄⁻, Al₂Cl₇⁻; BF₄⁻, PF₆⁻, ClO₄⁻, NO₃⁻, AsF₆⁻, SbF₆⁻, NbF₆⁻, TaF₆⁻, and (CN)₂N⁻. The anion moiety is preferably (perfluoroalkylsulfonyl) imide represented by the general formula (1), such as (CF₃SO₂)₂N⁻ or (C₂F₅SO₂)₂N⁻, in particular, preferably (trifluoromethanesulfonyl) imide such as (CF₃SO₂)₂N⁻.

Examples of organic salts of alkali metals include sodiumacetate, sodium alginate, sodium lignosulfonate, sodium toluenesulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K, and LiO₃S(CF₂)₃SO₃K. Among them, LiCF₃SO₃, Li(CF₃SO₂)₂N, Li(C₂F₅SO₂)₂N, Li(C₄F₉SO₂)₂N, Li(CF₃SO₂)₃C, and the like are preferred, fluorine-containing lithium imide salts such as Li(CF₃SO₂)₂N, Li(C₂F₅SO₂)₂N, and Li(C₄F₉SO₂)₂N are more preferred, and a (perfluoroalkylsulfonyl) imide lithium salt is particularly preferred.

Examples of inorganic salts of alkali metals include lithium perchlorate and lithium iodide.

### <Organic Cation-Anion Salt>

The organic cation-anion salt that may be used in the present invention includes a cationic component and an anionic component, in which the cationic component includes an organic material. Examples of the cationic component include a pyridinium cation, a piperidinium cation, a pyrrolidinium cation, a pyrroline skeleton-containing cation, a pyrrole skeleton-containing cation, an imidazolium cation, a tetrahydropyridinium cation, a dihydropyridinium cation, a pyrazolium cation, a pyrazolinium cation, a tetraalkylammonium cation, a trialkylsulfonium cation, and a tetraalkylsulfonium cation.

Examples of the anionic component that may be used include Cl, Br⁻, I⁻, AlCl₄⁻, Al₂Cl₇⁻, BF₄⁻, PF₆⁻, ClO₄⁻, NO₃⁻, CH₃COO—, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂)(CF₃CO)N⁻, and ⁻O₃S(CF₂)₃SO₃⁻, and those represented by the following general formulae (1) to (4):

(CₙF₂ₙ₊₁SO₂)₂N⁻ (1),

wherein n is an integer of 1 to 10;

CF₂(CₘF₂ₘSO₂)₂N⁻ (2),

wherein m is an integer of 1 to 10;

⁻O₃S(CF₂)ₗSO₃⁻ (3),

wherein l is an integer of 1 to 10; and

(CₚF₂ₚ₊₁SO₂)N⁻(C_{q}F_{2q+1}SO₂),

wherein p and q are each an integer of 1 to 10. In particular, a fluorine atom-containing anionic component is preferably used because it can form an ionic compound with good ionic dissociation properties. Especially, the anion component is preferably a fluorine-containing imide anion.

### <<Fluorine-Containing Imide Anion>>

Examples of the fluorine-containing imide anion include an imide anion having a perfluoroalkyl group.

Specifically, among the anion components provided above as examples, (CF₃SO₂)(CF₃CO)N⁻ and anions represented by the above formula (1), (2) or (4), and so forth are used:

(CₙF₂ₙ₊₁SO₂)₂N⁻ (1),

wherein n is an integer of 1 to 10;

CF₂(CₘF₂ₘSO₂)₂N⁻ (2),

wherein m is an integer of 1 to 10;

(CₚF₂ₚ₊₁SO₂)N⁻(C_{q}F_{2q+1}SO₂) (4),

wherein p and q are each an integer of 1 to 10. These fluorine-containing imide anions are preferably used because these can afford ionic compounds having improved ionic dissociability. The fluorine-containing imide anion is preferably one having a fluorinated alkyl or fluorinated alkylene group having 1 to 4 carbon atoms in order to successfully control the surface resistance value to be small and suppress nonuniformity of static electricity. The fluorine-containing imide anion is preferably (perfluoroalkylsulfonyl) imide represented by the general formula (1), such as (CF₃SO₂)₂N⁻ and (CF₅SO₂)₂N⁻, in particular, preferably (trifluoromethanesulfonyl) imide such as (CF₃SO₂)₂N⁻.

As a specific example of the organic cation-anion salt, a compound composed of a combination of the above-mentioned cation component and the above-mentioned anion component is suitably selected and used. Among the cation-anion salts, it is preferred in the present invention to use an onium-anion salt wherein the cation is an onium.

### <Onium>

The onium that constitutes the cation moiety in the onium-anion salt is a substance resulting from protonation of an atom that is to become an onium ion. From the viewpoint of inhibiting the degradation of a polarizer, the onium of the present invention is preferably one forming no onium salt via an unsaturated bond such as a double bond and a triple bond. That is, an organic onium in which an onium ion has been formed by substitution with an organic group or the like is preferred as the onium of the present invention.

Examples of the organic group in the organic onium include an alkyl group, an alkoxyl group, and an alkenyl group. Among these, one free from unsaturated bonds is preferred in order to suppress degradation of a polarizer. Although the number of carbon atoms of an alkyl group can be selected from 1 to 12, it is preferably 1 to 8, more preferably 1 to 4. Preferably, the organic onium is an alkyl onium wherein all the substituents thereof have alkyl groups having 1 to 4 carbon atoms. Although the alkyl group to be used may be a linear alkyl group or a branched alkyl group, a linear alkyl group is preferred. When the organic onium has a cyclic structure, the onium preferably has a 5-membered ring or a 6-membered ring and other substituents preferably have alkyl groups having 1 to 4 carbon atoms.

While the onium is not particularly restricted, examples thereof include nitrogen-containing oniums, sulfur-containing oniums, and phosphorus-containing oniums. Among these, nitrogen-containing oniums and sulfur-containing oniums are preferred.

Examples of the nitrogen-containing oniums include an ammonium cation, a piperidinium cation, a pyrrolidinium cation, a pyridinium cation, a cation having a pyrroline skeleton, a cation having a pyrrole skeleton, an imidazolium cation, a tetrahydropyrimidinium cation, a dihydropyrimidinium cation, a pyrazolium cation, and a pyrazolinium cation. Among these, an ammonium cation, a piperidinium cation, and a pyrrolidinium cation are preferred from the viewpoint of degradation of a polarizer, and especially, a pyrrolidinium cation is preferred. A tetraalkylammonium cation, an alkylpiperidinium cation and an alkylpyrrolidinium cation are preferred as a specific nitrogen-containing onium.

Examples of the sulfur-containing onium include a sulfonium cation. Examples of the phosphorus-containing onium include a phosphonium cation.

As the onium-anion salt, a compound composed of a combination of the above-mentioned onium component and the above-mentioned anion component is suitably selected and used. Among the onium-anion salts, an onium-fluorine-containing imide anion salt in which the anion is a fluorine-containing imide anion is preferred in the present invention.

As a specific example of the onium-fluorine-containing imide anion salt, a compound composed of a combination of the above-mentioned onium component and the above-mentioned fluorine-containing imide anion component is suitably selected and used, and at least one selected from nitrogen-containing onium salts, sulfur-containing onium salts and phosphorus-containing onium salts is preferably used. Moreover, at least one member selected from ammonium salts, pyrrolidinium salts, piperidinium salts and sulfonium salts is used preferably.

Examples thereof include 1-butyl-3-methylpyridinium bis(trifluoromethanesulfonyl)imide, 1-butyl-3-methylpyridinium bis(pentafluoroethanesulfonyl)imide, 1-ethyl-3-methylimidazolium bis(trifluoromethanesulfonyl)imide, 1-ethyl-3-methylimidazolium bis(pentafluoroethanesulfonyl)imide, 1-butyl-3-methylimidazolium bis(trifluoromethanesulfonyl)imide, 1,2-dimethyl-3-propylimidazolium bis(trifluoromethanesulfonyl)imide, tributylmethylammonium bis(trifluoromenthanesulfonyl)imide, tetrahexylammonium bis(trifluoromethanesulfonyl)imide, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium bis(trifluoromethanesulfonyl)imide, glycidyltolylmethylammonium bis(pentafluoroethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, and 1-butyl-3-methylpyridine-1-ium trifluoromethanesulfonate. Commercially available products of the above may be used, examples of which include CIL-314 manufactured by Japan Carlit Co., Ltd. and ILA2-1 manufactured by KOEI CHEMICAL COMPANY LIMITED.

Examples thereof also include tetramethylammonium bis(trifluoromethanesulfonyl)imide, trimethylethylammonium bis(trifluoromethanesulfonyl)imide, trimethylbutylammonium bis(trifluoromethanesulfonyl)imide, trimethylpentylammonium bis(trifluoromethanesulfonyl)imide, trimethylheptylammonium bis(trifluoromethanesulfonyl)imide, trimethyloctylammonium bis(trifluoromethanesulfonyl)imide, tetraethylammonium bis(trifluoromethanesulfonyl)imide, triethylbutylammonium bis(trifluoromethanesulfonyl)imide, tetrabutylammonium bis(trifluoromethanesulfonyl)imide, and tetrahexylammonium bis(trifluoromethanesulfonyl)imide.

Examples thereof further include 1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-heptylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1-propyl-1-butylpiperidinium bis(pentafluoroethanesulfonyl)imide, 1,1-dipropylpiperidinium bis(pentafluoroethanesulfonyl)imide, and 1,1-dibutylpiperidinium bis(pentafluoroethanesulfonyl)imide.

Examples thereof further include derivatives of the above compounds, in which the onium moiety is replaced by trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, or tetrahexylphosphonium cation.

Examples thereof further include derivatives of the above compounds, in which bis(trifluoromethanesulfonyl)imide is replaced by bis(pentafluorosulfonyl)imide, bis(heptafluoropropanesulfonyl)imide, bis(nonafluorobutanesulfonyl)imide, trifluoromethanesulfonylnonafluorobutanesulfonylimide, heptafluoropropanesulfonyltrifluoromethanesulfonylimide, pentafluoroethanesulfonylnonafluorobutanesulfonylimide, or cyclo-hexafluoropropane-1,3-bis(sulfonyl)imide anion.

As an onium-anion salt other than the onium-fluorine-containing imide anion salt, a compound composed of a combination of the above-mentioned onium component and the above-mentioned anion component other than the fluorine-containing imide anion salt is suitably selected and used. Examples thereof include 1-butylpyridinium tetrafluoroborate, 1-butylpyridinium hexafluorophosphate, 1-butyl-3-methylpyridiniumtetrafluoroborate, 1-butyl-3-methylpyridinium trifluoromethanesulfonate, 1-hexylpyridinium tetrafluoroborate, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazoliumtris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-hexyl-3-methylimidazolium bromide, 1-hexyl-3-methylimidazolium chloride, 1-hexyl-3-methylimidazolium tetrafluoroborate, 1-hexyl 3-methylimidazolium hexafluorophosphate, 1-hexyl 3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1-methylpyrazolium tetrafluoroborate, 3-methylpyrazolium tetrafluoroborate, diallyldimethylammonium tetrafluoroborate, diallyldimethylammonium trifluoromethanesulfonate, N,N-diethyl-N-methyl-N-(2-methoxyethyl) ammonium tetrafluoroborate, N,N-diethyl-N-methyl-N-(2-methoxyethyl)ammonium trifluoromethanesulfonate, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N,N-diethyl-N-methyl-N-(2-methoxyethyl)ammonium (trifluoromethanesulfonyl)trifluoroacetamide, diallyldimethylammonium (trifluoromethanesulfonyl)trifluoroacetamide, glycidyltrimethylammonium (trifluoromethanesulfonyl)trifluoroacetamide, and 1-butyl-3-methylpyridin-1-ium trifluoromethanesulfonate.

Besides the alkalimetal salts and the organic cation-anion salts, examples of the ionic compound further include inorganic salts such as ammonium chloride, aluminum chloride, copper chloride, ferrous chloride, ferricchloride, and ammoniumsulfate. These ionic compounds may be used alone or in combination of two or more.

The content of the ionic compound in the pressure-sensitive adhesive composition of the present invention is preferably from 0.0001 to 5 parts by weight based on 100 parts by weight of the (meth)acryl-based polymer. If the content of the ionic compound is less than 0.0001 parts by weight, the effect of improving antistatic performance may be insufficient. The content of the ionic compound is preferably 0.01 parts by weight or more, more preferably 0.1 parts by weight or more. On the other hand, if the content of the ionic compound is more than 5 parts by weight, durability may be insufficient. The content of the ionic compound is preferably 3 parts by weight or less, more preferably 1 part by weight or less. The content of the ionic compound can be set in a preferred range, taking into account the above upper and lower limits.

The pressure-sensitive adhesive composition of the present invention also includes a crosslinking agent. An organic crosslinking agent or a polyfunctional metal chelate may also be used as the crosslinking agent. Examples of the organic crosslinking agent include an isocyanate crosslinking agent, an epoxy crosslinking agent, a peroxide crosslinking agent and an imine crosslinking agent. The polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The crosslinking agent to be used is preferably selected from an isocyanate crosslinking agent and/or a peroxide crosslinking agent. Examples of such a compound for the isocyanate crosslinking agent include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate compounds produced by adding any of these isocyanate monomers to trimethylolpropane or the like; and urethane prepolymer type isocyanates produced by the addition reaction of isocyanurate compounds, burette type compounds, or polyether polyols, polyester polyols, acrylic polyols, polybutadiene polyols, polyisoprene polyols, or the like. Particularly preferred is a polyisocyanate compound such as one selected from the group consisting of hexamethylene diisocyanate, hydrogenated xylylene diisocyanate, and isophorone diisocyanate, or a derivative thereof. Examples of one selected from the group consisting of hexamethylene diisocyanate, hydrogenated xylylene diisocyanate, and isophorone diisocyanate, or a derivative thereof include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred, because their reaction with a hydroxyl group quickly proceeds as if an acid or a base contained in the polymer acts as a catalyst, which particularly contributes to the rapidness of the crosslinking.

Any peroxide capable of generating active radical species by heating or photoirradiation and promoting the crosslinking of the base polymer in the pressure-sensitive adhesive composition may be appropriately used. in view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the present invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.) di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

The amount of the crosslinking agent to be used is preferably from 0.01 to 20 parts by weight, more preferably from 0.03 to 10 parts by weight, based on 100 parts by weight of the (meth)acryl-based polymer. if the amount of the crosslinking agent is less than 0.01 parts by weight, the cohesive strength of the pressure-sensitive adhesive may tend to be insufficient, and foaming may occur during heating. If the amount of the crosslinking agent is more than 20 parts by weight, the humidity resistance may be insufficient, so that peeling may easily occur in a reliability test or the like.

One of the isocyanate crosslinking agents may be used alone, or a mixture of two or more of the isocyanate crosslinking agents may be used. The total content of the polyisocyanate compound crosslinking agent (s) is preferably from 0.01 to 2 parts by weight, more preferably from 0.02 to 2 parts by weight, even more preferably from 0.05 to 1.5 parts by weight, based on 100 parts by weight of the (meth)acryl-based polymer. The content may be appropriately controlled taking into account the cohesive strength or the prevention of peeling in a durability test or the like.

One of the peroxide crosslinking agents may be used alone, or a mixture of two or more of the peroxide crosslinking agent may be used. The total content of the peroxide(s) is preferably from 0.01 to 2 parts by weight, more preferably from 0.04 to 1.5 parts by weight, even more preferably from 0.05 to 1 part by weight, based on 100 parts by weight of the (meth)acryl-based polymer. The content of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

The pressure-sensitive adhesive composition of the present invention may further contain a silane coupling agent. The durability or the reworkability can be improved using the silane coupling agent. Examples of silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

One of the silane coupling agents (D) may be used alone, or a mixture of two or more of the silane coupling agents. The total content of the silane coupling agent(s) is preferably from 0.001 to 5 parts by weight, more preferably from 0.01 to 1 part by weight, even more preferably from 0.02 to 1 part by weight, still more preferably from 0.05 to 0.6 parts by weight, based on 100 parts by weight of the (meth)acryl-based polymer. The content of the silane coupling agent may be appropriately amount in order to control improve durability and maintain adhesive strength to the optical member such as a liquid crystal cell.

The pressure-sensitive adhesive composition of the present invention may also contain any other known additive. For example, a powder such as a colorant and a pigment, a tackifier, a dye, a surfactant, a plasticizer, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

The pressure-sensitive adhesive composition is used to form a pressure-sensitive adhesive layer. To form the pressure-sensitive adhesive layer, it is preferred that the total amount of the addition of the crosslinking agent should be controlled and that the effect of the crosslinking temperature and the crosslinking time should be carefully taken into account.

The crosslinking temperature and the crosslinking time may be controlled depending on the crosslinking agent used. The crosslinking temperature is preferably 170° C. or less.

The crosslinking process may be performed at the temperature of the process of drying the pressure-sensitive adhesive layer, or the crosslinking process may be separately performed after the drying process.

The crosslinking time is generally from about 0.2 to about 20 minutes, preferably from about 0.5 to about 10 minutes, while it may be set taking into account productivity and workability.

The separator-attached pressure-sensitive adhesive layer of the present invention can be produced by applying a solution containing the pressure-sensitive adhesive composition onto the release layer of the separator, and then drying the solution to form a pressure-sensitive adhesive layer. Before the pressure-sensitive adhesive composition is applied, appropriately, at least one solvent other than the polymerization solvent may be added to the pressure-sensitive adhesive composition.

Various methods may be used to apply the pressure-sensitive adhesive composition. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

A heat drying temperature of the coating film is preferably from 40° C. to 200° C., more preferably from 50° C. to 180° C., particularly preferably from 70° C. to 170° C. The heating temperature to be used in performing crosslinking using a peroxide as a crosslinking agent is preferably 140° C. or more, more preferably 150° C. or more in terms of crosslinking efficiency and productivity.

A proper period of time can be employed appropriately as the drying time. The drying time is preferably 30 seconds to 3 minutes, and especially, a drying time of 40 seconds to 2 minutes is preferred in terms of productivity, drying efficiency, and crosslinking efficiency.

The thickness of the pressure-sensitive adhesive layer is typically, but not limited to, from about 1 to 100 μm, preferably from 2 to 50 μm, more preferably from 2 to 40 μm, further preferably from 5 to 35 μm.

Preferably, the gel fraction of the pressure-adhesive layer of the present invention is higher at the time of formation of the pressure-sensitive adhesive layer (initial stage). If the gel fraction is high, then it is possible to inhibit generation of dot traces caused by contaminants being present between films and it is also possible to perform processing such as cutting immediately after forming a pressure-sensitive adhesive layer. The gel fraction of the pressure-sensitive adhesive layer is preferably 70% by weight or more, more preferably 80% or more. The gel fraction of the pressure-sensitive adhesive layer can be controlled by heating conditions, for example. Setting the heating temperature to 140° C. or more can make the gel fraction to be 70% by weight or more, and setting the heating temperature to 150° C. or more can make the gel fraction to be 80% by weight or more. The gel fraction is measured in accordance with the disclosure of examples.

A pressure-sensitive adhesive layer-attached optical film with a separator can be formed by sticking the separator-attached pressure-sensitive adhesive layer of the present invention to at least one side of an optical film, and then transferring the pressure-sensitive adhesive layer to the optical film.

As the optical film, one that is used for the formation of an image display device such as a liquid crystal display device can be used, and the type thereof is not particularly restricted. Examples of the optical film include a polarizing film. Polarizing films having a transparent protective film on one side or both sides of a polarizer are commonly used.

A thin polarizer with a thickness of 10 μm or less may also be used. In view of thinning, the thickness is preferably from 1 to 7 μm. Such a thin polarizer is less uneven in thickness, has good visibility, and is less dimensionally-variable and therefore has high durability. It is also preferred because it can form a thinner polarizing film.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol-based film, partially formalized polyvinyl alcohol-based film, and ethylene-vinyl acetate copolymer-based partially saponified film; poly-ene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used.

A polarizer that is uniaxially stretched after a polyvinyl alcohol-based film dyed with iodine is obtained by stretching a polyvinyl alcohol-based film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

Typical examples of such a thin polarizer include the thin polarizing layers disclosed in JP-A No. 51-069644, JP-A No. 2000-338329, WO2010/100917, specification of PCT/JP2010/001460, specification of Japanese Patent Application No. 2010-269002, or specification of Japanese Patent Application No. 2010-263692. These thin polarizing layers can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

Among processes including the steps of stretching and dyeing a laminate, a process capable of high-ratio stretching to improve polarizing performance is preferably used to obtain the thin polarizing layer. Therefore, the thin polarizing layer is preferably obtained by a process including the step of stretching in an aqueous boric acid solution as disclosed in WO2010/100917, the specification of PCT/JP2010/001460, the specification of Japanese Patent Application No. 2010-269002, or the specification of Japanese Patent Application No. 2010-263692, in particular, preferably obtained by a process including the step of performing auxiliary in-air stretching before stretching in an aqueous boric acid solution as disclosed in the specification of Japanese Patent Application No. 2010-269002 or the specification of Japanese Patent Application or 2010-263692.

The polarizer and the transparent protective film are bonded together using an adhesive. For example, the adhesive may be an isocyanate-based adhesive, a polyvinyl alcohol-based adhesive, a gelatin-based adhesive, a vinyl latex-based adhesive, an aquatic polyester-based adhesive, or the like. The adhesive is generally used in the form of an aqueous solution, which generally has a solids content of 0.5 to 60% by weight. Besides the above, the adhesive between the polarizer and the transparent protective film may also be an ultraviolet-curable adhesive, an electron beam-curable adhesive, or the like. Electron beam-curable adhesives for polarizing films have good tackiness to the above various transparent protective films. The adhesive for use in the present invention may also contain a metal compound filler.

The other optical films include optical layers, such as a reflective plate, a transflective plate, a retardation film (a half wavelength plate and a quarter wavelength plate included), and a viewing angle compensation film, which may be used for formation of a liquid crystal display etc. These are used in practice as a polarizing film, or as one layer or two layers or more of optical layers laminated with polarizing film.

The pressure-sensitive adhesive layer-attached optical film with a separator of the present invention is used practically as a pressure-sensitive adhesive layer-attached optical film by peeling the separator off. The pressure-sensitive adhesive layer-attached optical film of the present invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive layer-attached optical film and optionally other component such as a lighting system and incorporating a driving circuit according to any conventional technique, except that the pressure-sensitive adhesive layer-attached optical film of the present invention is used. Any type of liquid crystal cell may also be used such as a TN type, an STN type, a n type a VA type and IPS type.

Suitable liquid crystal displays, such as liquid crystal display with which the pressure-sensitive adhesive layer-attached optical film has been located at one side or both sides of the liquid crystal cell, and with which a backlight or a reflective plate is used for a lighting system may be manufactured. In this case, the pressure-sensitive adhesive layer-attached optical film may be installed in one side or both sides of the liquid crystal cell. When installing the optical films in both sides, they may be of the same type or of different type. Furthermore, in assembling a liquid crystal display, suitable parts, such as diffusion layer, anti-glare layer, antireflection film, protective plate, prism array, lens array sheet, optical diffusion sheet, and backlight, may be installed in suitable position in one layer or two or more layers.

### Examples

The present invention is more specifically described by the examples below, which are not intended to limit the scope of the present invention. In each example, parts and % are all by weight. Unless otherwise stated below, the conditions of room temperature standing are 23° C. and 65% RH in all the cases.

### <Measurement of Weight Average Molecular Weight of (Meth)Acryl-Based Polymer>

The weight average molecular weight (Mw) of the (meth)acryl-based polymer was measured by GPC (Gel Permeation Chromatography).

Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mmp×30 cm, 90 cm in total
Column temperature: 40° C.
Flow rate: 0.8 ml/minute
injection volume: 100 μl
Eluent: tetrahydrofuran
Detector: differential refractometer (RI)
Standard sample: polystyrene

### Production Example 1

### Preparation of Acryl-Based Polymer (A)

A reaction vessel equipped with a cooling tube, a nitrogen introduction tube, a thermometer, and a stirring device was charged with a monomer mixture containing 99 parts of butyl acrylate and 1 part of 4-hydroxybutyl acrylate. Moreover, 2,2-azobisisobutyronitrile was charged as a polymerization initiator together with ethyl acetate in an amount of 0.1 parts per 100 parts of the monomer mixture (solid component). After introducing nitrogen gas to replace the atmosphere with nitrogen under stirring slowly, a polymerization reaction was performed for 7 hours while maintaining the liquid temperature within the reaction vessel near 60° C. Then, ethyl acetate was added to the resulting reaction liquid, so that a solution of acryl-based polymer (A) having a weight average molecular weight of 1,600,000 was prepared, the solid concentration of the solution having been adjusted to 30%.

### Production Example 2

### Preparation of Acryl-Based Polymer (B)

A solution of acryl-based polymer (B) having a weight average molecular weight of 1,600,000 was prepared in the same way as in Production Example 1 except that a monomer mixture containing 96 parts of butyl acrylate, 3 parts of acrylic acid, and 1 part of 4-hydroxybutyl acrylate was used as the monomer mixture in Production Example 1.

### Example 1

### Preparation of Pressure-Sensitive Adhesive Composition

To the obtained acryl-based polymer (A) solution in an amount of 100 parts in terms of the solid content thereof were incorporated 0.1 parts of trimethylolpropane xylylene diisocyanate (manufactured by Mitsui Chemicals, Inc.; Takenate D110N), 0.3 parts of dibenzoyl peroxide, and 0.2 parts of γ-glycidoxypropylmethoxysilane (manufactured by Shin-Etsu Chemical Co, Ltd.; KBM-403) as crosslinking agents and 1 part of 1-ethyl-1-methylpyrrolidinium trifluoromethanesulfonylimide as an ionic compound, so that a solution of a pressure-sensitive adhesive composition was obtained.

### <Preparation of Separator>

### <<Formation of Oligomer Prevention Layer>>

A coating liquid was prepared by diluting an organosiloxane (Ethyl Silicate 48; manufactured by Colcoat Co., Ltd.) with isopropyl alcohol to a solid concentration of 1%. The coating liquid was applied to one side of a 38 μm thick polyethylene terephthalate film (base film: PET film) with a gravure coater so as to have a thickness of 50 nm after drying and then was dried at 120° C. Thus, an oligomer prevention layer was formed.

### <<Formation of Release Layer>>

A solution of a silicone-based release agent was prepared by diluting 20 parts by weight of a silicone resin (KS-847H; manufactured by Shin-Etsu Chemical Co., Ltd.) and 0.2 parts by weight of a curing agent (PL-50T; manufactured by Shin-Etsu Chemical Co., Ltd.) with 350 parts by weight of a methyl ethyl ketone/toluene mixed solvent (mixing ratio=1:1). The solution of the silicone-based release agent was applied to the above-mentioned oligomer prevention layer with a gravure coater so as to have a thickness of 100 nm after drying and then was dried at 120° C. to form a release layer. Thus, a separator having a configuration of base film/oligomer prevention layer/release layer was obtained.

### <Preparation of Separator-Attached Pressure-Sensitive Adhesive Layer>

The solution of the pressure-sensitive adhesive composition prepared above was applied with a fountain coater uniformly to the release layer of the separator and then was dried for 60 seconds in an air circulation type thermostat oven at 150° C. to form a 20 μm thick pressure-sensitive adhesive layer on the surface of the release layer. Thus, a separator-attached pressure-sensitive adhesive layer was obtained.

### <Preparation of Polarizing Film>

A process for forming a thin polarizing layer was performed. in the process, a laminate including an amorphous PET substrate and a 9 μm thick PVA layer formed thereon was first subjected to auxiliary in-air stretching at a stretching temperature of 130° C. to forma stretched laminate. Subsequently, the stretched laminate was subjected to dyeing to form a colored laminate, and the colored laminate was subjected to stretching in an aqueous boric acid solution at a stretching temperature of 65° C. to a total stretch ratio of 5.94 times, so that an optical film laminate was obtained, which had a 4 μm thick PVA layer stretched together with the amorphous PET substrate. Such two-stage stretching successfully formed an optical film laminate having a 4 μm thick PVA layer, which was formed on the amorphous PET substrate, contained highly oriented PVA molecules, and formed a highly-functional polarizer in which iodine absorbed by the dyeing formed a polyiodide ion complex oriented highly in a single direction. A 80 μm thick saponified triacetylcellulose film was further stuck to the surface of the polarizer of the optical film laminate, while a polyvinyl alcohol-based adhesive was applied to the surface, and then the amorphous PET substrate was peeled off, so that a polarizing film with a thin polarizer was obtained.

### <Preparation of Pressure-Sensitive Adhesive Layer-Attached Polarizing Film>

Subsequently, the above-mentioned separator-attached pressure-sensitive adhesive layer was stuck to a thin polarizer of the above-mentioned polarizing film and then the pressure-sensitive adhesive layer was transferred. Thus, a pressure-sensitive adhesive layer-attached polarizing film with a separator was obtained.

### Examples 2 to 6 and Comparative Examples 1 to 7

Separator-attached pressure-sensitive adhesive layers were prepared and moreover pressure-sensitive adhesive layer-attached polarizing films with separators were prepared in the same way as in Example 1 except that the type of the acryl-based polymer and the type and the amount of the ionic compound in <Preparation of pressure-sensitive adhesive composition>, the type of the forming agent of the oligomer prevention layer in <<Formation of oligomer prevention layer>>, and the heating conditions (temperature, time) in <Preparation of separator-attached pressure-sensitive adhesive layer> in Example 1 were changed as shown in Table 1.

The following evaluations were carried out for the separator-attached pressure-sensitive adhesive layers and the pressure-sensitive adhesive layer-attached polarizing films with separators obtained in the examples and comparative examples. The results are given in Table 1.

### <Measurement of Gel Fraction of Pressure-Sensitive Adhesive Layer>

From a separator-attached pressure-sensitive adhesive layer was taken about 0.2 g of a pressure-sensitive adhesive layer, which was then wrapped in fluororesin (TEMISH NEF-1122, manufactured by Nitto Denko Corporation) whose weight (Wa) was measured in advance. The fluororesin was then bound so that the pressure-sensitive adhesive layer would not leak, followed by measurement of the weight (Nb) thereof, and then was put into a sample bottle. Ethyl acetate in an amount of 40 cc was added, followed by leaving at rest for 7 days. Thereafter the fluororesin was taken out and subsequently was dried on an aluminum cup at 130° C. for 2 hours. The weight (Wc) of the fluororesin containing the sample was measured and then a gel fraction was calculated from the following formula (I).

Gel fraction(5 by weight)=(Wc−Wa)/(Wb−Wa)×100

### <Method for Measuring Surface Resistance Value of Release Layer>

The surface resistance value (Ω/□) of the surface of a release layer of a separator was measured using MCP-HT450 manufactured by Mitsubishi Chemical Analytech Co., Ltd.

### <Evaluation of Static Electricity-Induced Unevenness>

The prepared pressure-sensitive adhesive layer-attached polarizing film was cut into a piece with a size of 100 mm×100 mm, which was bonded to a liquid crystal panel. The panel was placed on a backlight with a brightness of 10,000 cd, and the orientation of the liquid crystal was disturbed using 5 kV static electricity produced by an electrostatic generator, ESD, (ESD-8012A, manufactured by Sanki Electronic Industries Co., Ltd.). The time required for recovery from the orientation failure-induced display failure was measured using an instantaneous multichannel photodetector system (MCPD-3000, manufactured by Otsuka Electronics Co., Ltd.), and evaluated according to the criteria below.

◯: Display failure was eliminated in a time of one second to less than 10 seconds.
x: Display failure was eliminated in a time of 10 seconds or more.

### <Method for Measuring Amount of PET Oligomer Migration>

A pressure-sensitive adhesive layer-attached polarizing film with a separator was left at rest for 500 hours under conditions of 60° C. and 90% RH, and then the separator was removed. From the pressure-sensitive adhesive layer-attached polarizing film was taken about 0.025 g of the pressure-sensitive adhesive layer (sample), to which 1 ml of chloroform was then added and shaken at room temperature for 18 hours, followed by addition of 5 ml of acetonitrile, extraction, and shaking for 3 hours. The resulting solution was filtered through a 0.45 ml membrane filter, thereby preparing a sample. Standard samples of a PET oligomer trimer were adjusted to prescribed concentrations and a calibration curve was prepared, and then the amount (ppm) of a PET oligomer contained in a pressure-sensitive adhesive was determined by using the calibration curve. The calibration curve was measured and produced with HPLC using samples whose PET oligomer concentrations (ppm) were known.

HPLC device: 1200 Series manufactured by Agilent Technologies

Measurement Conditions

Column: ZORBAX SB-C18 manufactured by Agilent Technologies

Column temperature: 40° C.

Column flow rate: 0.8 ml/min

Eluent composition: water/acetonitrile reversed-phase gradient condition

Injection amount: 5 μl

Detector: PDA

Quantification method: Standard samples of a PET oligomer trimer were dissolved in chloroform and then diluted with acetonitrile, thereby preparing standard samples having prescribed concentrations. A calibration curve was produced on the basis of the HPLC areas and the adjusted concentrations, and then the PET oligomer amounts of samples were determined.

TABLE 1

| | Pressure-sensitive adhesive composition | | | | | | Separator | | | | |
|---|---|---|---|---|---|---|---|---|---|---|---|
| | Acryl-based | | | | Heating | | | Release | Evaluation | | |
| | polymer | | | | condition | | Oligomer | layer | Initial | | Amount of PET |
| | | part(s) | Ionic | | Heating | Heating | prevention | Surface | gel | | oligomer |
| | | by | compound | | temperature | time | layer | resistance | fraction | Antistatic | migration |
| | Type | weight | Type | part(s) | (° C.) | (sec) | Type | value | (%) | performance | (ppm) |
| Example 1 | A | 100 | *1 | 1 | 150 | 60 | Silica-based | 1.0 × 10¹³< | 83 | ◯ | 10 |
| Example 2 | A | 100 | *1 | 1 | 150 | 40 | Silica-based | 1.0 × 10¹³< | 80 | ◯ | 5 |
| Example 3 | A | 100 | *1 | 1 | 140 | 40 | Silica-based | 1.0 × 10¹³< | 72 | ◯ | 2 |
| Example 4 | A | 100 | *2 | 1 | 150 | 60 | Silica-based | 1.0 × 10¹³< | 83 | ◯ | 11 |
| Example 5 | A | 100 | *3 | 1 | 150 | 60 | Silica-based | 1.0 × 10¹³< | 83 | ◯ | 9 |
| Example 6 | B | 100 | *1 | 1 | 150 | 60 | Silica-based | 1.0 × 10¹³< | 82 | ◯ | 10 |
| Comparative | A | 100 | — | 0 | 150 | 60 | Quaternary | 1.1 × 10¹¹ | 84 | X | 10 |
| Example 1 | | | | | | | ammonium salt | | | | |
| Comparative | A | 100 | — | 0 | 140 | 40 | Quaternary | 1.1 × 10¹¹ | 72 | X | 8 |
| Example 2 | | | | | | | ammonium salt | | | | |
| Comparative | A | 100 | *1 | 1 | 150 | 60 | Quaternary | 1.1 × 10¹¹ | 83 | ◯ | 200 |
| Example 3 | | | | | | | ammonium salt | | | | |
| Comparative | A | 100 | *1 | 1 | 140 | 40 | Quaternary | 1.1 × 10¹¹ | 72 | ◯ | 180 |
| Example 4 | | | | | | | ammonium salt | | | | |
| Comparative | A | 100 | — | 0 | 150 | 60 | No blocking | 1.0 × 10¹³< | 83 | X | 300 |
| Example 5 | | | | | | | layer | | | | |
| Comparative | A | 100 | *2 | 1 | 150 | 60 | Quaternary | 1.1 × 10¹¹ | 82 | ◯ | 220 |
| Example 6 | | | | | | | ammonium salt | | | | |
| Comparative | A | 100 | *3 | 1 | 150 | 60 | Quaternary | 1.1 × 10¹¹ | 83 | ◯ | 240 |
| Example 7 | | | | | | | ammonium salt | | | | |

In the column “ionic compound” in Table 1,
“*1” represents 1-ethyl-1-methylpyrrolidinium bis(trifluoromethanesulfonyl)imide,
“*2” represents tributylmethylammonium bis(trifluoromethanesulfonyl)imide, and
“*3” represents lithium bis (trifluoromethanesulfonyl)imide.
“Silica-based” in the column “oligomer prevention layer” is the same as the forming agent of the oligomer prevention layer used in Example 1, and the “quaternary ammonium salt” is a mixture of 60 parts of an acrylic polymer containing a 2-hydroxy-3-metacryloxvpropyltrimethylammonium salt as a monomer unit (counter ion: methylsulfonate salt), 30 parts of a polyethylene glycol-containing acrylate polymer, and 10 parts of an oxazoline crosslinking agent (EPOCROS WS500, manufactured by Nippon Shokubai Co., Ltd.).

What is claimed is:

1. A separator-attached pressure-sensitive adhesive layer comprising a pressure-sensitive adhesive layer on a separator, wherein
the separator includes a base film and an oligomer prevention layer, and a release layer provided in this order on the base film, and the release layer has a surface resistance value of 1.0×10¹³Ω/□ or more, and
the pressure-sensitive adhesive layer is formed from a pressure-sensitive adhesive composition comprising a base polymer and an ionic compound and is provided on the release layer of the separator.

2. The separator-attached pressure-sensitive adhesive layer according to claim 1, wherein the oligomer prevention layer is a layer formed of a silica-based material.

3. The separator-attached pressure-sensitive adhesive layer according to claim 1, wherein the ionic compound is an alkali metal salt and/or an organic cation-anion salt.

4. The separator-attached pressure-sensitive adhesive layer according to claim 1, wherein the base polymer is a (meth)acryl-based polymer.

5. The separator-attached pressure-sensitive adhesive layer according to claim 4, wherein the (meth)acryl-based polymer comprises an alkyl (meth)acrylate monomer unit and a hydroxyl group-containing monomer unit.

6. The separator-attached pressure-sensitive adhesive layer according to claim 4, wherein the (meth)acryl-based polymer comprises an alkyl (meth)acrylate monomer unit and a carboxyl group-containing monomer unit.

7. A method for producing the separator-attached pressure-sensitive adhesive layer according to claim 1, comprising the steps of:
applying a solution of a pressure-sensitive adhesive composition comprising a base polymer and an ionic compound to a release layer of a separator, the separator including a base film and an oligomer prevention layer, and the release layer provided in this order on the base film, and the release layer having a surface resistance value of 1.0×10¹³Ω/□ or more, and
heating the applied solution of the pressure-sensitive adhesive composition at a temperature of 140° C. or more.

8. A pressure-sensitive adhesive layer-attached optical film with a separator, wherein the separator-attached pressure-sensitive adhesive layer according to claim 1 is stuck to at least one side of the optical film.
